(19) United States
(12) Patent Application Publication
(10) Pub. No.: US 2009/0166369 A1
(43) Pub. Date: Jul. 2, 2009

(54) CONTAINER HAVING AN ARTICULATED COVER

(76) Inventor: Alan F. Savicki, Yorkville, IL (US)

Correspondence Address: THE CLOROX COMPANY, P.O. BOX 24305, OAKLAND, CA, 94623-1305, US

(21) Appl. No.: 12/298,722

(22) PCT Filed: May 1, 2007
(86) PCT No.: PCT/US07/67953

§ 371 Date: Oct. 27, 2008

Related U.S. Application Data
(60) Provisional application No. 60/803,675, filed on Jun. 1, 2006.

(51) Int. Cl. B65D 43/03; B28B 7/44

(52) U.S. Cl. 220/781; 249/119

(57) ABSTRACT

The covers stack together in two different ways. First, the covers can be stacked into an “aligned” stack. The aligned stack provides structural rigidity for bulk handling during manufacturing. Second, the covers can be stacked into a “locked” stack. The locked stack provides even more structural rigidity than does the aligned stack and is useful when storing unused covers. The cover includes a first closure portion, an engagement portion, and an alignment portion. The base includes a second closure portion. The first closure portion of the cover is sealingly engageable with the second closure portion of the base to define a sealed storage area. The alignment portion of the cover is engageable with the alignment portion of a second cover to form an aligned cover stack. The engagement portion of the cover is engageable with the engagement portion of a second cover to form a locked cover stack. The cover further includes at least one articulation element circumscribing the engagement portion of the cover and that provides flexibility to the cover allowing the engagement portion of the cover to easily articulate upwardly or downwardly.

### FIELD OF THE INVENTION

The present invention relates generally to a plastic container having a cover and a base, which when sealingly engaged together form a sealed storage area, and, more particularly, to container covers that telescope or articulate from a first position to a second position below or above the first position. Multiple covers of the plastic containers may be aligned together when stacked in a first position and may be locked together in a second position.

### BACKGROUND OF THE INVENTION

Rigid, thermoplastic food containers are generally known. Users often accumulate a large number of these containers in different sizes and shapes. When not in use, the containers are often stored haphazardly into drawers. In this case, the unused containers take up a great deal of room, and finding a matching base and cover in a disarranged drawer may be difficult. To avoid this, some users stack the containers in cabinets. While the bases of the containers usually nest and therefore take up less room than in a disorganized drawer, it may still be difficult to match a base with a cover. In addition, the covers may not stack and the covers may tend to topple down. When the containers are in use to store food, the containers are often stacked one on top of another in cabinets or in a refrigerator. These stacks may be precarious, and their fall may cause food to spill from the containers. Many users would find it desirable if the containers, whether empty or in use, could be stored in a manner space efficient, less precarious, and more structurally rigid. Related U.S. Provisional Patent Application No. 60/655,830, describes a system of interlocking covers for sealable plastic containers and is hereby incorporated by reference in its entirety.

During large-scale manufacturing, the covers may be transported in bulk before being separated out for individual packaging. During bulk handling, manufacturers would find it desirable if the covers would form a stack stable enough to resist the vertical and lateral movements caused by forces typically encountered during manufacturing operations. The present invention has as a general aim to provide containers that satisfy both users and manufacturers.

Users would find it desirable to provide containers that advantageously create a partial vacuum within the sealed storage area of the container during use. Still further, users would find desirable a cover that holds items in place within the container or that expands somewhat to accommodate larger items. Still further user would find it desirable to have covers that provide for cover interlocking while at the same time allow for stacking of additional containers on top of the cover of a first container. What is needed is a cover of improved flexibility that can provide these advantages.

### SUMMARY OF THE INVENTION

In view of the foregoing, the present invention provides containers whose covers can be stacked together in two different ways. First, the covers can be stacked into an “aligned” stack. The aligned stack provides enough structural rigidity for bulk handling during manufacturing. Second, the covers can be stacked into a “locked” stack. The locked stack provides even more structural rigidity than does the aligned stack and is useful when storing unused covers.

In some embodiments, the cover includes a first closure portion, an engagement portion, and an alignment portion. The base includes a second closure portion. The first closure portion of the cover is sealingly engageable with the second closure portion of the base to define a substantially sealed, leak-proof, and re-sealable storage area for items such as food. The alignment portion of the cover is engageable with the alignment portion of a second cover to form an aligned cover stack. The engagement portion of the cover is engageable with the engagement portion of a second cover to form a locked cover stack.

Further, the covers of the present invention include articulation elements that allow the covers to easily flex upwardly or downwardly, sometimes referred to as articulate, either alone or when engaged with the base of the container. A protruding engagement portion of the cover may be articulated downwardly to the level of the top of the remaining portions of the cover.

The covers and bases can be economically constructed from relatively thin-gauge plastic so that the user can either wash them after use or dispose of them with the view that their purchase price allows them to be used as a consumable good. The container can be readily manufactured, for example, with conventional vacuum thermoforming equipment. The cover can be made from a semi-transparent material to ensure satisfactory visibility of the container's contents. The container can be suitable for refrigerator, freezer, microwave, and machine dishwasher use.

The features of the present invention will become apparent to one of ordinary skill in the art upon reading the detailed description, in conjunction with the accompanying drawings, provided herein.

### BRIEF DESCRIPTION OF THE DRAWINGS

FIG. 1 is an isometric view of a container with a cover and a base according to an embodiment of the present invention;

FIG. 2 is a top plan view of the cover of FIG. 1;

FIG. 3 is a bottom plan view of the cover of FIG. 1;

FIG. 4 is an isometric view of the base of FIG. 1;

FIG. 5 is a partial isometric sectional view with the engagement portion of the cover of FIG. 1 locking engaged with and engagement portion of a second cover;

FIG. 6A is an isometric view of the cover of FIG. 1 with the cover in a neutral position;

FIG. 6B is a side sectional view of the cover of FIG. 6A taken along a midline of the cover;

FIG. 7A is an isometric view of the cover of FIG. 1 with the cover with the cover in a partial downwardly flexed position;

FIG. 7B is a side sectional view of the cover of FIG. 7A taken along a midline of the cover;

FIG. 8A is an isometric view of the cover of FIG. 1 with the cover in a full downwardly flexed position;

FIG. 8B is a side sectional view of the cover of FIG. 8B taken along a midline of the cover;

FIG. 9A is partial close-up view of the cover of FIG. 6B showing the engagement portion and an articulation element of the cover;

FIG. 9B is partial close-up view of the cover of FIG. 7B showing the engagement portion and an articulation element of the cover;

FIG. 9C is partial close-up view of the cover of FIG. 8B showing the engagement portion and an articulation element of the cover;

FIG. 10 is a side sectional view of a container having a cover according to the present invention in sealing engagement with a base and having a second base stacked above the container;

FIG. 11A is a side sectional view of a cover removed from a vacuum thermoforming mold use to make the cover; and

FIG. 11B is a close-up of a portion of the vacuum thermoforming mold of FIG. 11A showing an articulation element of the cover formed in the mold.

### DETAILED DESCRIPTION OF THE INVENTION

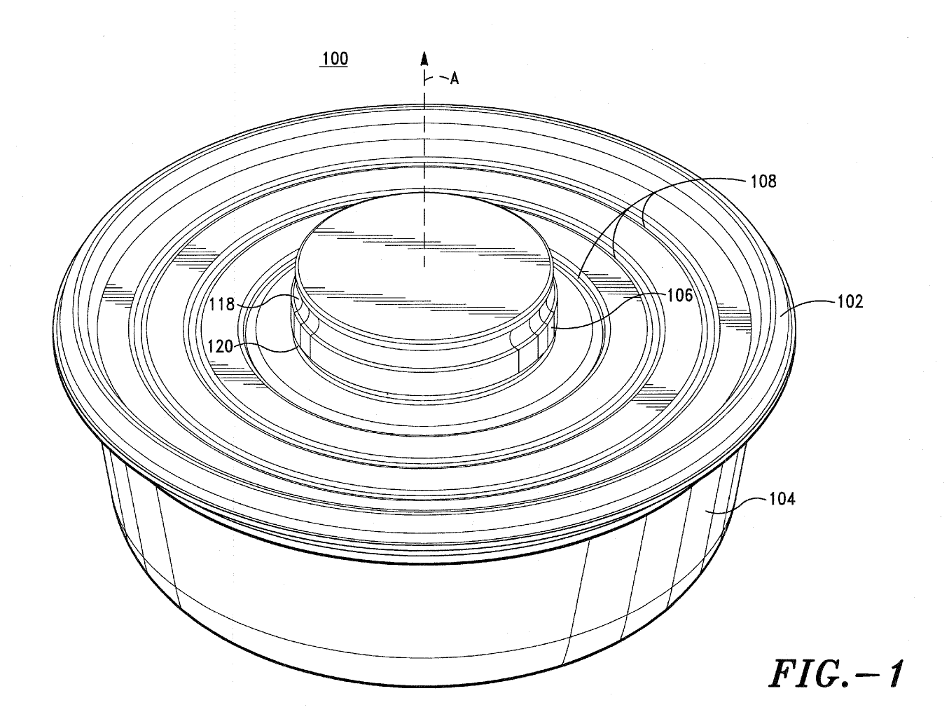

Turning to the drawings, wherein like reference numerals refer to like elements, an embodiment of the present invention is illustrated in FIGS. 1 through 4. A container 100 includes a flexible cover 102 sealingly engaged to a base 104. In the example of FIGS. 1 through 4, the container 100 is depicted as substantially circular in top plan view. In other embodiments of the present invention, the container 100 has other shapes such as rectangular, square, or elliptical.

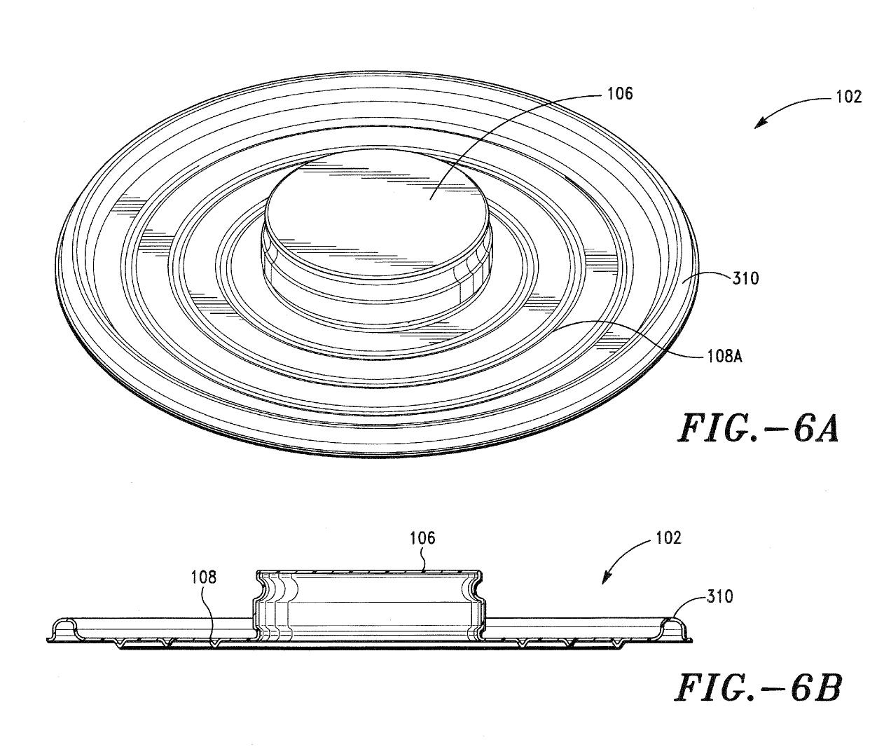

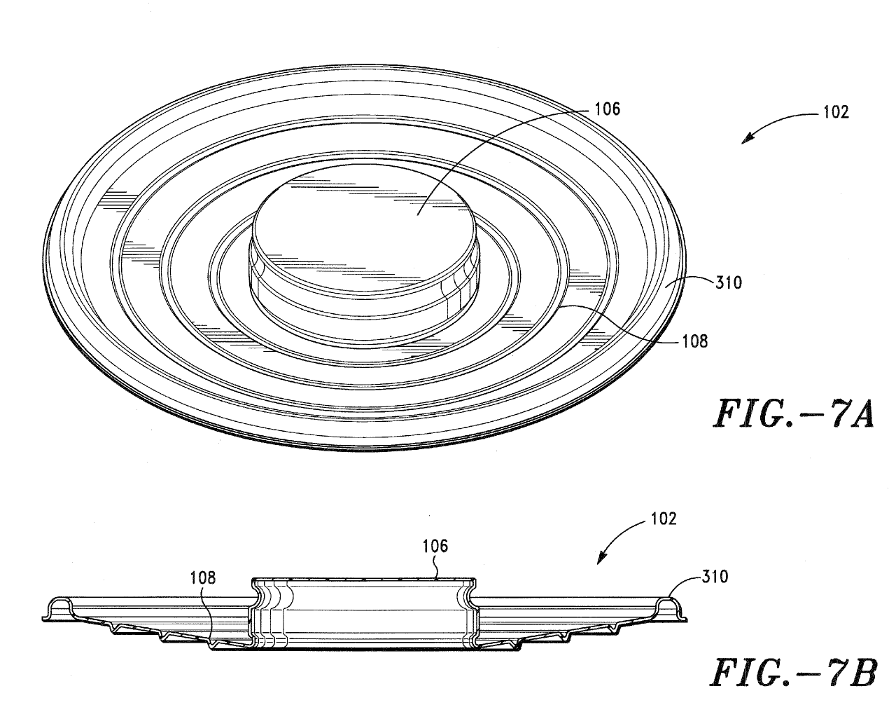

The cover 102 includes an engagement portion 106 that is lockingly engageable with the engagement portion of a second cover (not shown in FIG. 1, see FIG. 5). As described more fully below with reference to FIGS. 6A through 9C, circumscribing the engagement portion 106 of the cover 102 is at least one articulation element 108. The engagement portion 106 of the Figures is depicted as circular but, as with the shape of the container 100 itself, other shapes are possible. In some embodiments, a standard shape and configuration of the engagement portion 106 is used with covers 102 of various shapes and sizes. This enhances storage flexibility by allowing different types of covers 102 to be stored together in a locked stack.

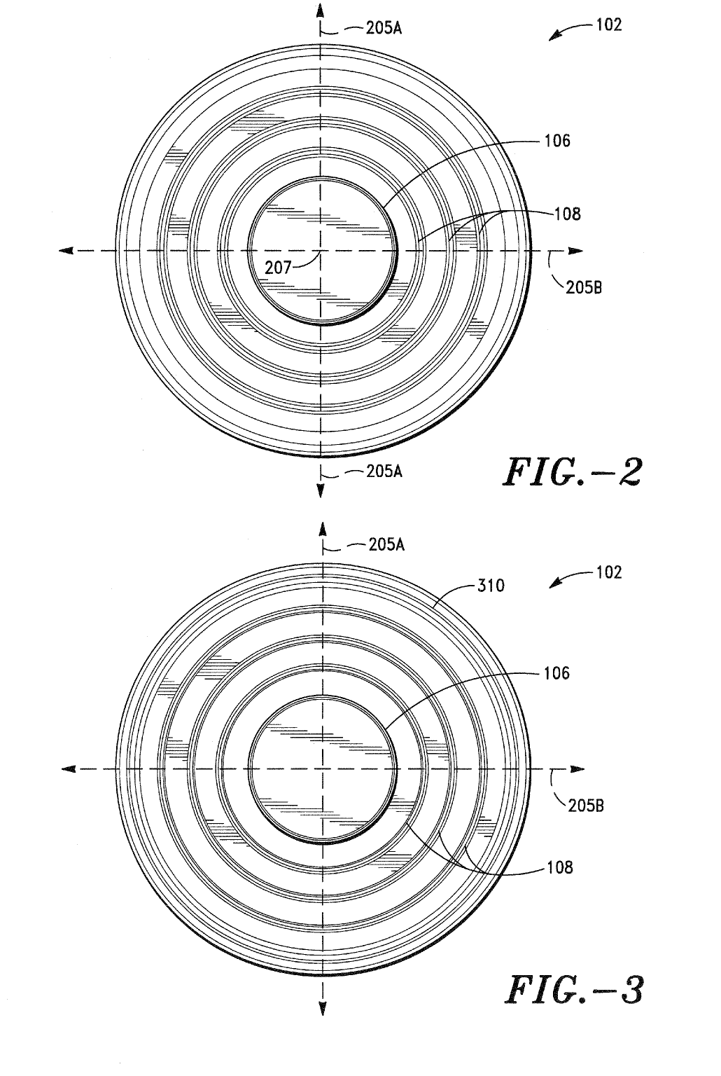

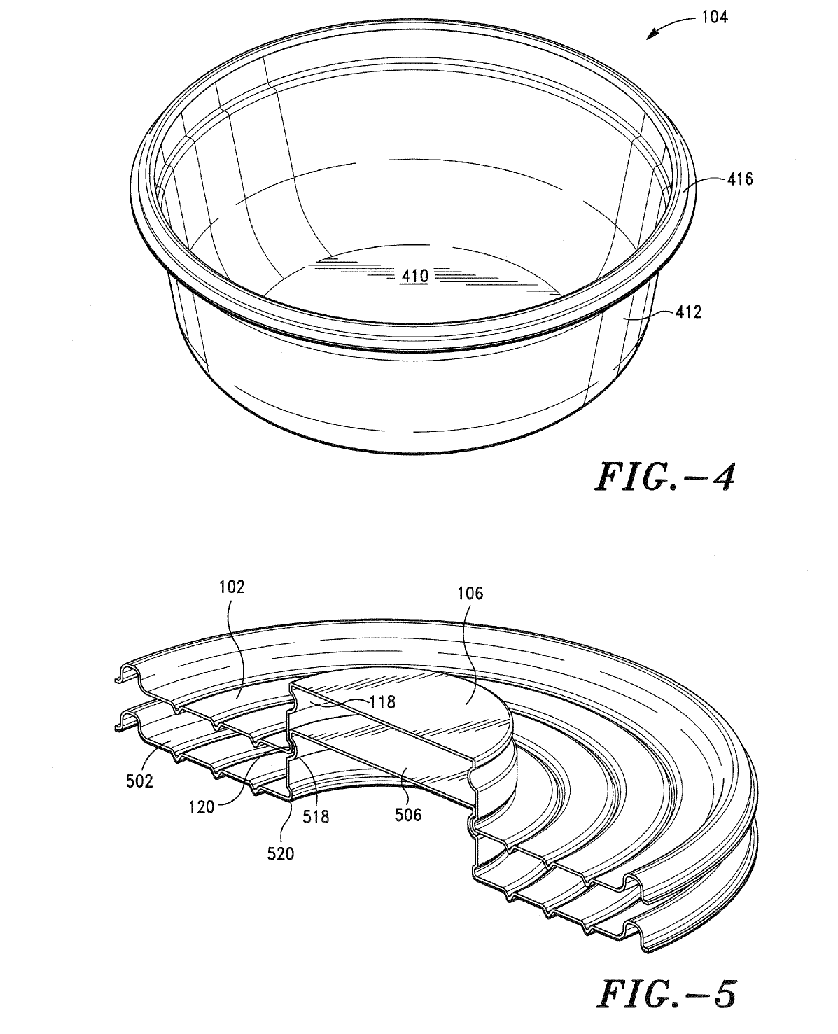

The cover 102 includes a first closure portion 310 (FIG. 3). The first closure portion 310 is sealingly engageable with a second closure portion 416 (FIG. 4) of the base 104. The first closure portion 310 of the cover 102 can be sealingly engaged with a second closure portion 416 of the base 104 to provide a leak-resistant, re-sealable closure. When the first closure portion 310 of the cover 102 and the second closure portion 416 of the base 104 are abutted and sealingly engaged with each other, the cover 102 and the base 104 define a substantially sealed storage area within container 100 (FIG. 1).

As shown in FIG. 4, the base 104 of the container 100 includes a bottom 410 and a peripheral sidewall 412 extending upwardly from the peripheral edge of the bottom 410. The top of the base 104 is open. The second closure portion 416 of the base 104, which, as noted above, is adapted to sealingly engage with the first closure portion 310 of the cover 102, is positioned at the open end of the peripheral sidewall 412 of the base 104. In one embodiment, the second closure portion 416 of the base 104 is a raised locking ring that extends from an upper edge of the peripheral sidewall 412 of the base 104.

More particularly with reference to the engagement portion 106, the cover 102 illustrated in FIGS. 1, 2, 3 and 5 includes the engagement portion 106 that allows the cover 102 to lockingly engage with the engagement portion 506 of a second cover 502 to form a locked stack of covers (FIG. 5). This locking feature makes the resultant stack of covers more structurally rigid and thus less precarious than a traditional, non-interlocked, stack of covers.

A shown in FIG. 5 the cover 102 is locked together with the second cover 502 by their engagement portions 106 and 506 respectively. In the example of FIG. 5, the engagement portion 106 of the cover 102 includes an upper protrusion 118 (see also FIG. 1) and a lower protrusion 120. Further, the engagement portion of the second cover 502 likewise includes an upper protrusion 518 and a lower protrusion 520. Each protrusion 118, 518, 120, and 520 is convex on one side and concave on the other. The lower protrusion 120 of the cover 102 fits over and receives the upper protrusion 518 of the second cover 502, thus locking the covers 102 and 502 together. In this manner, the covers 102 and 502 are held together and form a structurally stable cover stack. A third cover (not shown) may be lockingly engaged with the second cover 502, a fourth cover with the third and so on to form a stack of any number of covers.

The engagement portion 106 can also be chosen to have a shape or otherwise include elements that provide an aligned or locked stack of covers 102 with rotational alignment. Rotation, as used herein, is defined about an axis A (FIG. 1) normal to the plane formed by orthogonal midlines, i.e., first midline 205A and second midline 205B at the top surface of the cover 102 as shown in FIG. 2. The origin of the rotational axis is at the center point 207 at which the orthogonal midlines intersect. For instance, shapes that inherently require alignment prior to engagement or that may be self-aligning during the process of connecting engagement portions would be shapes with linear or curvilinear sides, vertices or lobes such as triangular, square, rectangular, or multi-petal shapes. Additionally, the cover may have one or more elements on or about the engagement portion that require alignment prior to connection of engagement portions or elements that may be self-aligning during the process of connecting engagement portions.

Other embodiments of the engagement portion may include one or more of the following features to enable engagement: convex portions or ribs, concave portions or ribs, linear or curvilinear undercuts, discrete snap elements or buttons, interference fits, textured surfaces, or elements that modify surface friction or tackiness at or around the point of engagement. The engaging areas that create a locking condition can be continuous about the engagement portions or discretely segmented about the engagement portions. In some embodiments, the force required to connect the cover and the second cover may differ substantially from the force required to disengage the covers. For instance, it may be beneficial during manufacturing that the force needed to connect the covers is less than the force required to separate the covers. As a result, the covers are relatively easy to connect during manufacturing, yet they will lock securely and not undesirably separate during the manufacturing process. To accomplish this, the protrusions on the engagement portion may be designed where, for a given protrusion, the upper protrusion edge comprises a gradual taper whereas the lower protrusion edge comprises a more abrupt shape. For example, in one embodiment, the shape of the protrusion may be similar to a barbed hook with gradual taper on the upper edge of the barb that would impart little resistance during engagement and with an abrupt shape on the lower edge of the barb that would impart relatively high resistance during disengagement. Conversely, it may be beneficial to design the engagement portion so that the force that needs to be applied to connect the covers is more than the force required to separate the covers, since the user may perceive that a high connecting force equates to satisfactory locking integrity, whereas a weak connecting force may lead the user to perceive that the cover stack lacks the integrity required to insure the expected organizational benefit. Thus, the high connecting force provides the perceived benefit, yet a lower disengagement force does not require that the user untowardly struggle during separation of covers. To accomplish this, the protrusions on the engagement portion may be designed where, for a given protrusion, the upper protrusion edge comprises an abrupt shape whereas the lower protrusion edge comprises a more gradual taper. For example, in one embodiment, the shape of the protrusion may be a reversed barb with an abrupt shape on the upper edge of the barb that would impart relatively high resistance during engagement and with a gradual taper on the lower edge of the barb that would impart little resistance during disengagement. Furthermore, during the process where the user applies force to aligned covers in a direction normal to the general cover plane so as to lock the covers together, the engagement portion can provide tactile or audible feedback upon locking. In this way, the user would sense that the covers are connected and that no further force need be applied.

More particularly with regard to the first closure portion 310 and the second closure portion 416 forming the sealing engagement of the cover 102 and the base 104, FIG. 3 is a bottom plan view of the cover of FIG. 1. Referring to FIGS. 1, 3, and 4, as noted above, the cover 102 of the container 100 may sealingly engaged with the base 104 of the container 100. The cover 102 includes the first closure portion 310 (FIG. 3) in the form of receiver at the perimeter edge of the cover 102 adapted to sealingly engage the second closure portion 416 in the form of the raised locking ring at the top edge of the peripheral sidewall 412 of the base 104. As a result, when the cover 102 and the base 104 are abuttingly engaged, a positive seal is formed between sealing surfaces around the perimeters of the base 104 and of the cover 102. In this embodiment, the container 100 uses a locking rim design that includes both inside and outside seals. As would be apparent to one of ordinary skill in the art however, the present invention can be embodied with a variety of closure designs including outer closures and/or inner closures. Related U.S. Provisional Patent Application No. 60/655,830, co-owned with the present invention and incorporated in its entirety herein by reference, further describes the closure portions. However, the closure portions described therein are examples only, and many other types of closure portions could be used with the present invention.

The first and second closure portions 310 and 416 can be configured to be slightly different in size to form an interference fit therebetween. The interference fit between the first and second closure portions 310 and 416 can provide a sealing engagement between the closure portions. As a result, when the two pieces are abuttingly engaged, a positive seal can be formed between the first and second sealing surfaces around the perimeters of the base 104 and of the cover 102. The sealing engagement of the first and second closure portions 300 and 404 can be accompanied by an audible “snap” indicating that the container is securely closed.

The base 104 of FIGS. 1 and 4 can be made from any suitable plastic with sufficient thickness to withstand without deforming the heat of microwave cooking and of top-shelf dishwashing. It should also remain sturdy during lifting while laden with hot food. The base 104 can be made from any suitable plastic and can be made by any suitable technique, such as co-extrusion, lamination, injection molding, vacuum thermoforming, or overmolding. In one embodiment, the base 104 is formed from polypropylene. As with the cover 102, the nominal wall thickness of the base 104 can vary somewhat due to the manufacturing process.

The cover 102 of FIG. 1 can be constructed with a wall thickness thinner than that of a base 104. The cover 102 can be made from any suitable plastic and can be made by any suitable technique, such as vacuum thermoforming processes described herein. In one embodiment, the cover 102 can be formed from polypropylene. Due to the vacuum thermoforming process, the wall thickness of the cover 102 can vary slightly over its nominal thickness. A cover 102 with a nominal thickness less than the nominal thickness of the base 104, however, reduces the cost of material for the container 100. Further, with a thinner cover 102, increased cover flexibility more easily accommodates the removal of the cover 102 from, and the sealing engagement with, the base 104. The cover 102 can maintain adequate flexibility for proper sealing even during typical freezer temperatures.

FIGS. 6A through 10 show the utility of an embodiment of the present invention when the containers are in use or storage. As described above and referring to FIGS. 1, 6A and 6B in one embodiment, cover 102 defines at least one articulation element 108, such as first articulation element 108A. Articulation element 108 is configured as a “V” shaped groove or indentation into the top of the cover 102. The articulation element 108 has its opened end at the top surface of the cover 102 and its vertex below the bottom surface of the cover 102. In one embodiment, articulation elements 108 circumscribe engagement portion 106 of the cover 102.

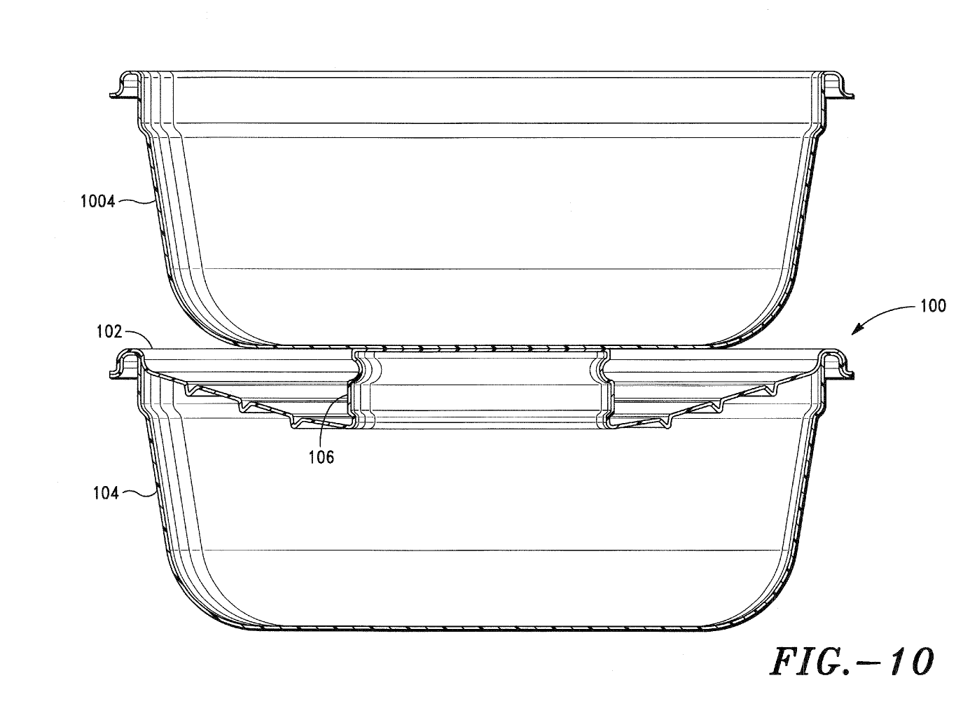

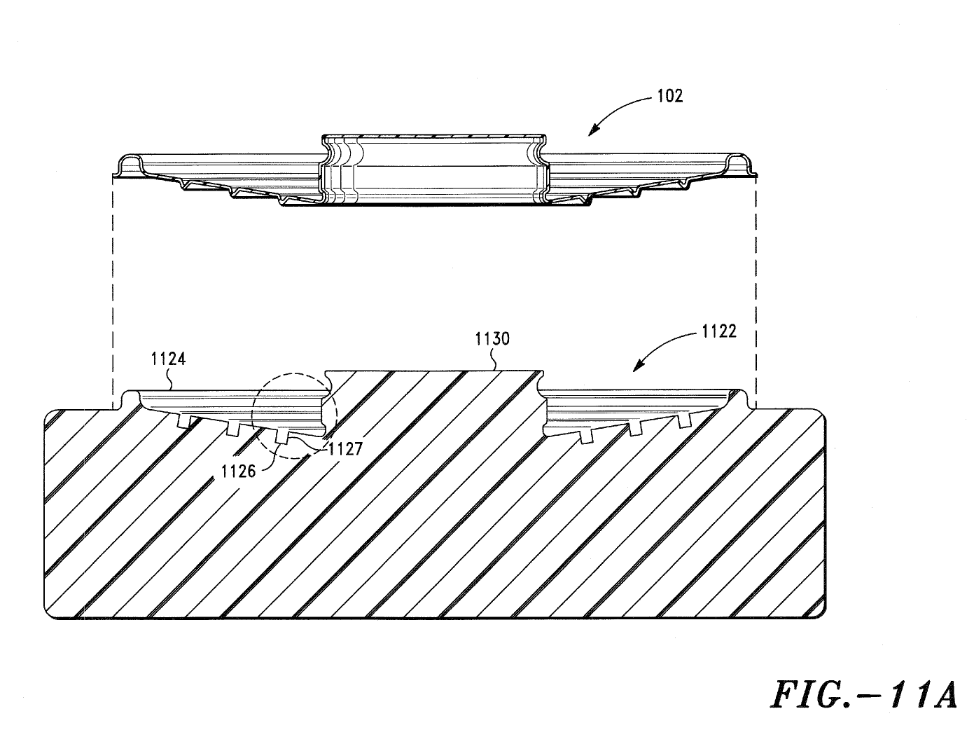

In FIGS. 1, 6A, 6B, and 9A the cover 102 is shown in a “neutral” position, where no force outside the cover 102 impinges on the top or bottom surfaces of the cover 102 that would motivate the cover 102 to flex upwardly or downwardly from the position of the cover 102 shown in FIG. 1 when the cover 102 is sealingly engaged with the base 104 of container 100. In the neutral position shown in the Figures, the top of engagement portion 106 is above the top of the first closure portion 310 of the cover 102. Further, in the neutral position shown, the opened end of the “V” shaped articulation element 108 has a neutral dimension Xn (FIG. 9A).

If a user of container 100 supplies a sustained downwardly directed force on the top of the engagement portion 106 while supporting the peripheral edge of the cover 102 at its first closure portion 310 the cover 102 is biased downwardly forcing the cover 102 to assume a downwardly directed generally conical shape. Since the cover 102 is formed from flexible material, a return force is imparted upon the cover 102 by the elastic properties of the material of the cover 102. This return force will urge the cover 102 to return to its neutral position.

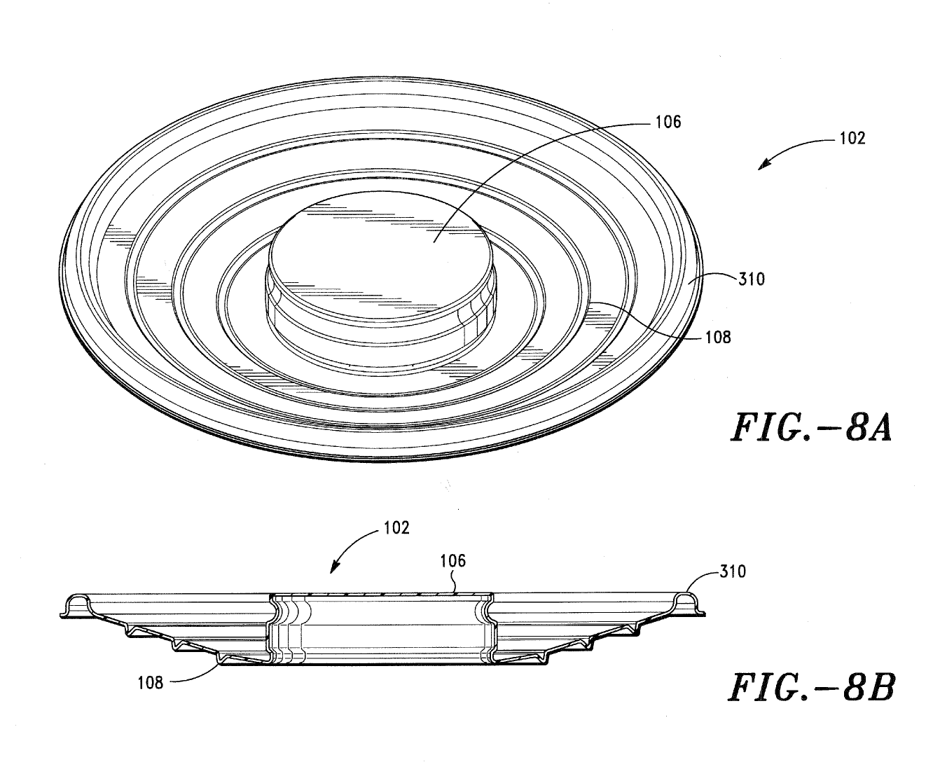

In FIGS. 7A, 7B, and 9B the cover 102 has been flexed somewhat downwardly to a “midway” position by sustained application of a first force by a user on the top of the engagement portion 106. In this midway position, the engagement portion 106 has been lowered relative to the first closure portion 310 of the cover 102 when compared to the cover 102 shown in the neutral position of FIGS. 6A, 6B and 9A. Further, in the midway position shown, the opened end of the “V” shaped articulation element 108 has a midway dimension Xm (FIG. 9B) that is greater than the neutral dimension Xn (FIG. 9A) when the cover 102 is in the neutral position shown in FIGS. 1, 6A, 6B, and 9A. The opened end of the “V” shaped articulation element 108 has expanded to accommodate the downward flexing of the cover 102 from its neutral position. Said another way, the vertex of the articulation element 108 forms a living hinge, well know to those of ordinary skill in the art, that allows the legs of the “V” shaped articulation element 108 to pivot relative to each other to expand the open end of the “V” shaped articulation element 108. Thus, the articulation element 108 provides additional flexibility to the cover 102 beyond that supplied by the elasticity of the flexible material of construction of the cover 102. As described more fully below, if articulation element 108 is thinner that the rest of the cover 102 still further additional flexibility and ease of articulation is provided to the cover 102 since thinner material forming an articulation element 108 will more easily yield to downward force than will thicker material.

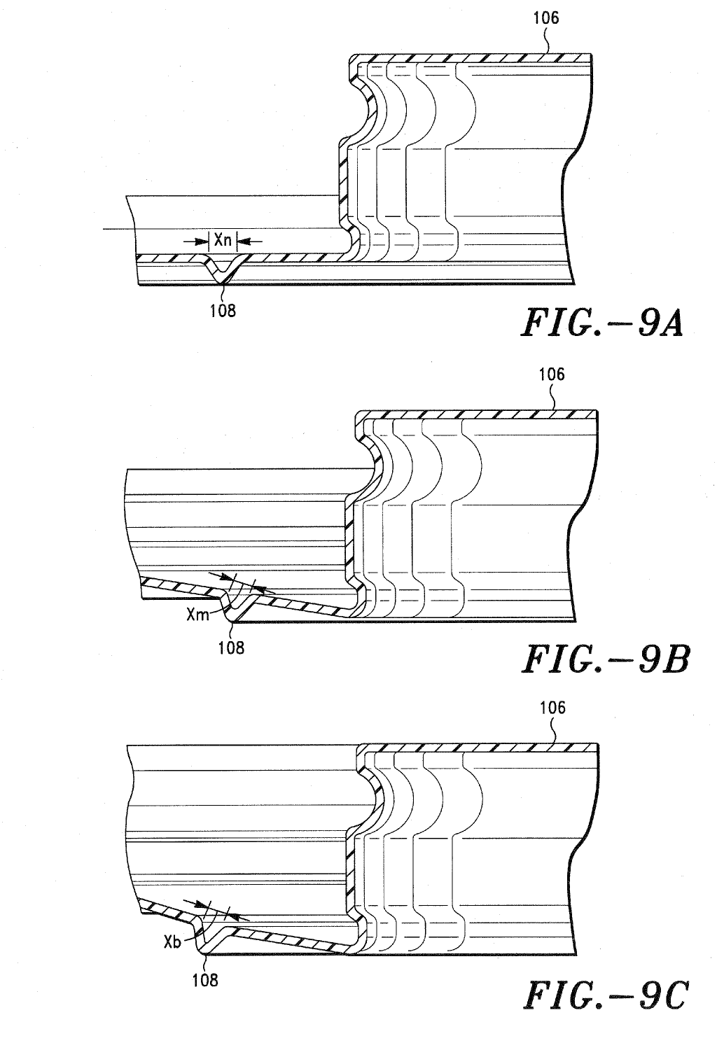

In FIGS. 8A and 8B, the cover 102 has been flexed yet further downwardly beyond the midway position shown in FIGS. 7A and 7B to a “bottom” position by the application of a sustained second force greater than the first force that flexed the cover 102 to its midway position. In this bottom position, the engagement portion 106 has been further lowered so that the elevation of the top of the engagement portion 106 coincides with the elevation of the top of the first closure portion 310 of the cover 102. In addition, in the position shown in FIGS. 8A and 8B, the opened end of the “V” shaped articulation element 108 has expanded still further to have a bottom dimension Xb (FIG. 9C) that is greater than the midway dimension Xm of FIGS. 7A and 7B. The opened end of the “V” shaped articulation element 108 has expanded still further to accommodate the further downward flexing of the cover 102 from its midway position shown in FIGS. 7A and 7B to its bottom position shown in FIGS. 8A and 8B.

Thus, the articulation element 108 provides additional flexibility to the cover 102 to allow the engagement portion 106 to move downwardly relative to the position of the engagement portion 106 when the cover is in the neutral position of FIGS. 6A and 6B. It would be readily apparent to one skilled in the art that articulation element 108 also provides additional flexibility when a sustained upwardly directed force impinges on engagement portion 106. In this instance, cover 106 assumes an upwardly directed conical shape.

The articulation element 108 provides advantages to cover 102 over prior art covers. For example, FIG. 10 is a side sectional view of a container 100 having a cover 102 according to the present invention in sealing engagement with a base 104 and having a second base 1004 stacked above the container 100. The weight of the second base 1004 and its contents provides the sustained force necessary to articulate the engagement portion 106 of the cover 102 downwardly to the bottom position shown (see also FIGS. 8A and 8B). Thus, the engagement portion 106 provides no impediment to the stacking of the second base 1004 onto the cover 102 of the container 100. Likewise, there is no need to provide a nesting cavity or indent into the bottom of the second base 1004 to accommodate the engagement portion 106 that extends above the top of the cover 102 when the cover 102 is the neutral and midway positions shown in FIGS. 7A, and 8A, respectively. In one embodiment, the engagement portion 106 of the cover 102 is easily articulated downwardly and is pressed out of the way of the second base 1004 by the weight of the second base 1004 and its contents stacked above, thereby obviating the need for this nesting cavity in the bottom of the base 1004. In addition, the articulation of the covers 104 allows the engagement portion 106 to be designed into the cover 104 to easily facilitate nesting or stacking of multiple covers 104 during production without having to use part of the engagement portion 106 as a primary stack.

Other uses for the articulation feature of the cover 102 may include creating a partial vacuum seal in the container 100 of FIG. 1. By first disengaging a part of the perimeter seal formed between the first closure portion 310 of the cover 102 and the second closure portion 416 of the base 104 and next flexing the cover 102 downwardly (FIGS. 7B and 8B) prior to resealing the container 100, a partial vacuum is created. The cover 102, and the engagement portion 106 coupled thereto, are motivated to return to the neutral position (FIGS. 6A and 6B) by the upwardly biasing elastic force created by the downward flexing of the cover 102 by a user of container 100. As the cover 102 moves upwardly to return to its neutral position, a partial vacuum is created inside the container as the volume of the enclosed space defined by the container 100 increases when the cover 102, motivated by elastic forces, moves upwardly relative to base 104 to which the cover 102 is sealingly engaged. The internal air pressure within the storage area defined by the cover 102 and the base 104, to which it is sealingly engaged, is lowered. The internal pressure is lowered since the volume of the container increases as the cover 102 moves upwardly while to amount or mass of air within the container 100 remains constant. The partial vacuum created in the storage area of container 100 itself restrains the cover 102 from returning to its full neutral position. Since, under these partial vacuum conditions, the cover 102 does not return fully to its neutral position, another use of the articulation feature of the cover 102 includes pressing upon and holding an article, such as a sandwich, more tightly inside the closed and sealed container 100.

The cover 102 can be made by various plastic molding processes, including but not limited to vacuum thermoforming and injection molding. Vacuum thermoforming of the cover 102 is typically the most economical means for forming the cover 102. As is well know in the art, vacuum thermoforming involves the heating a suitable plastic sheet of material to a temperature at which the sheet becomes formable into a shape that is set as the plastic sheet cools. As used herein, a suitable plastic sheet is a plastic sheet that may be readily used by the vacuum thermoforming process. The heated plastic sheet is made to conform to the surface features of a single surface “male” tool by drawing the heated sheet of plastic to the surface of the tool by the force of a vacuum applied to the tool. In vacuum thermoforming, the sealed air space between the heated plastic and mold is evacuated to draw the heated plastic to contact the single male surface of the mold.

Typically, however, in vacuum thermoforming, the thickness of the finished article formed by the process is nominally uniform. A side cross-section view through the vacuum thermoformed article reveals a substantially uniform thickness profile. The “bottom” surface of the heated plastic sheet that contacts the tool surface conforms to its shape. The “top” surface of the plastic element formed in the vacuum thermoforming process does not contact a tool surface and generally resides at a uniform distance from the bottom surface of the plastic article. Only nominal thinning of the plastic material occurs when it bends and stretches around curved mold features to conform to the path of the curved surfaces of these features. As used herein, a substantially uniform thicknesses in side cross-sectional profile is a thickness in a plastic article that is not sufficiently variable to preclude its manufacture with typical prior art single male surface vacuum thermoforming techniques. Conversely, a non-uniform thickness is a profile thickness in an article that varies enough to preclude the manufacture of the article with standard prior art vacuum thermoforming techniques requiring instead other plastic molding techniques such as injection molding.

Injection molding of a plastic article involves heating suitable plastic material in the form of pellets or granules until a melt is obtained. The melt is next forced into a split-die mold, sometimes referred to as a split-die tool, where it is allowed to “cool” into the desired shape. Both the bottom surface and the top surface of the plastic article are formable by the split-die mold. Thus, articles may by formed by the injection molding process that have side cross-sectional profiles of varying non-uniform thickness. After the plastic melt cools, the split-die mold is opened and the article is ejected. Since, the mold is separable, undercut surface on the plastic article may be relieved from the split-die mold when it is opened. Injection molding, well know in the art, is typically used to form plastic articles that have large undercuts and substantially varying thicknesses in side cross-sectional profile. As used herein undercuts are said to be large if a molded plastic article having undercut features is difficult or impossible to remove from a single-surface vacuum thermoforming mold after it is formed and cooled.

Since cover 102 as described, contains significant undercuts, such as included in upper protrusion 118 and lower protrusion 120 (FIGS. 1 and 5) on the engagement portion 106 of the cover 102, injection molding would typically be required to form cover 102. Further, injection molding would typically be required to form articulation elements 108 that are significantly thinner than the rest of cover 102.

A method of forming the articulated cover of the present invention using vacuum thermoforming techniques is next described. As noted above, it is advantageous that the articulation element 108 of the cover 102 has a side cross-sectional profile thickness that is less than the thickness of the cover 102. As also noted above, typical vacuum thermoforming, techniques produce plastic articles that have substantially uniform thickness profiles.

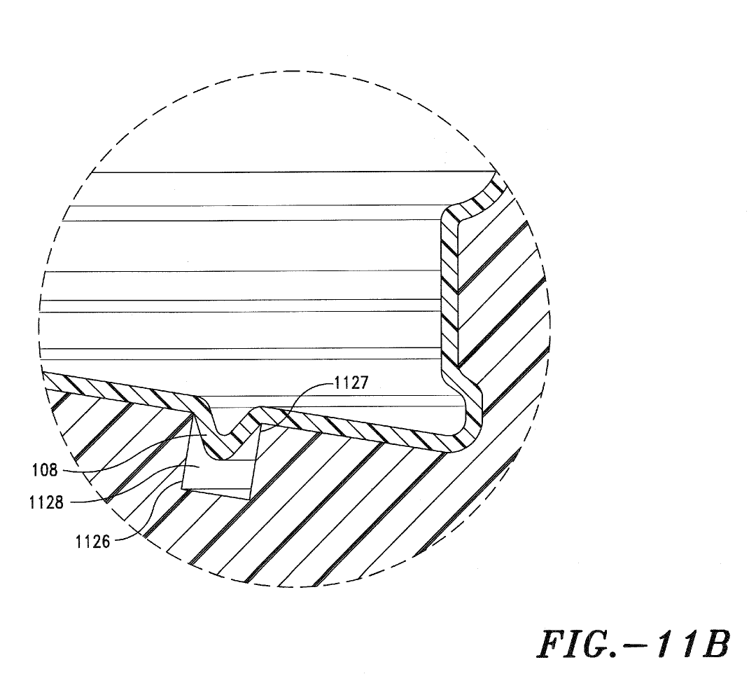

FIG. 11A shows a vacuum thermoforming mold 1122 that is used to form the cover 102 of the present invention by the vacuum thermoforming process. In the figure, a cover 102, which is made with the thermoforming mold 1122, is shown removed from and above the thermoforming mold 1122. Thermoforming mold 1122 is a single male surface mold having only a bottom-forming surface 1124 that is used to shape the bottom surface of the cover 102. Thermoforming mold 1122 has at least one mold indent 1126 having an open end 1127 and projecting into the bottom-forming surface 1124 of the thermoforming mold 1122 to define a open-ended cavity 1128 therein. In one embodiment, mold indent 1126 is rectangular shaped in cross section and circumscribes an engagement portion mold element 1130 used to form the engagement portion 106 of the cover 102. As described and illustrated more fully below, rectangular shaped mold indent 1126 of the thermoforming mold 1122 is used to form the living hinge articulation element 108 of the cover 102.

FIG. 11B shows a close-up view of the area of FIG. 11A indicated in dashed line and having a cover 102 being formed by the vacuum thermoforming process. Referring to FIGS. 11A and 11B together, after a suitable plastic sheet is heated and placed over the thermoforming mold 1122. The heated plastic sheet is made to conform to the bottom forming surface 1124 used to shape the bottom surface of the cover 102 by drawing the heated plastic sheet to the bottom forming surface 1124 by the force of a vacuum applied to the thermoforming mold 1122. As the air space between the heated plastic sheet and the thermoforming mold 1122 is evacuated, the heated plastic sheet seals off the open end 1127 of the mold indent 1126 of the thermoforming mold 1122. Unless a vacuum is separately supplied to the cavity 1128 defined by the mold indent 1126, no drawing of the part of the heated plastic sheet overlying and sealing off the opened end 1127 the mold indent 1126 is possible.

In accordance with the principles of the present invention and as best seen in FIG. 11B, in one embodiment, a separate, controllable vacuum system (not shown) supplies a variable vacuum to the one or more mold indents 1126 of the thermoforming mold 1122. By supplying a separate vacuum to the mold indent 1126 after the heated plastic sheet has sealed off the open end 1127 of the mold indent 1126, the overlying heated plastic material may be drawn into the cavity 1128 defined by the mold indent 1126. As the strength of the separate controllable vacuum supplied to the mold indent 1126 is increased, the plastic material overlying the open end 1127 of the mold indent 1126 may be drawn into the cavity 1128 formed by the mold indent 1126. In one embodiment, the overlying plastic material does not contact the mold interior surface 1129 but remains suspended within the interior of the cavity 1128.

In this manner, the living hinge of the cover 102 is formed. Since the plastic material overlying the open end 1127 of the mold indent 1126 is drawn into the rectangular cavity 1128 of the mold indent 1127, the overlying plastic material is elongated, stretched, and drawn into a “V” shaped feature that is less thick than the rest of the cover 102. By increasing the strength of the separate vacuum supplied to the mold indent 1126, the depth of the “V” shaped articulation element 108 may be increased and its thickness decreased. Thus, the living hinge at the vertex of the articulation element 108 may be decreased in thickness when compared to the thickness of the remaining portions of the cover 108. Advantageously, the thickness of the living hinge may be varied in this manner without the need for retooling of the thermoforming mold 11122.

The container 100 can be reusable, but it can also be constructed cheaply enough that consumers see it as a disposable item, with replacement covers 102 and bases 104 available separately for retail sale. The base 104 and the cover 102 can be fabricated by vacuum thermoforming a clarified polypropylene homopolymer material. In another embodiment, the container 100 may be fabricated by vacuum thermoforming a clarified random copolymer polypropylene material. Other plastic materials which would be suitable for fabricating the cover 102 and the base 104 of the container 100 by vacuum thermoforming include PS (polystyrene), CPET (crystalline polyethylene terephthalate), APET (amorphous polyethylene terephthalate), HDPE (high density polyethylene), PVC (polyvinyl chloride), PC (polycarbonate), and foamed polypropylene. The material used can be generally transparent to allow a user to view the contents of the container.

The container 100 may include a visual indication of closure between the cover 1102 and the base 104. The visual indication may be a color change in the area where the cover 102 engages the base 104. In one embodiment, the first closure portion 310 on the cover 102 may be a first color and the second closure portion 416 on the base 104 may be a second color. When the closure portions are engaged, the first and second colors produce a third color which is visible to the user to indicate that the container 100 is sealed.

The container 100 may include a rough exterior surface to reduce slipping and to improve grasping by the user, especially if the user's hands are wet or greasy.

The container 100 may include a self-venting feature. The pressure in the sealed container 100 may increase when the sealed container 100 and contents are heated in a microwave oven. Thus, the cover 102 may include a self-venting mechanism, which opens when the pressure in the container 100 exceeds a predetermined value.

The container 100 may be divided to separate foods in the container. A divider may be integral with the container 100 or may be a separate component. Either the base 104 only may include a divider or both the base 104 and the cover 102 may each include a divider. The divider located in the cover 102 may only partially engage the divider in the base 104 so as to provide splash protection, or it may fully engage the divider in the base 104 to provide varying degrees of inter-compartmental leak resistance.

The container 100 may include a strip indicating the temperature of the container 100 and its contents.

The use of the terms “a,” “an,” “the,” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise indicated.

While the invention is described herein in connection with certain preferred embodiments, there is no intent to limit the present invention to those embodiments. For example, those of skill in the art would recognize that may be formed such that the vertex of the articulation element 108 is above the top of the cover 108, that is the articulation elements 108 may be pointed upwardly. It is recognized that various changes and modifications to the described embodiments will be apparent to those skilled in the art upon reading the foregoing description, and that such changes and modifications may be made without departing from the spirit and scope of the present invention. Skilled artisans may employ such variations as appropriate, and the invention may be practiced otherwise than as specifically described herein. Accordingly, the intent is to cover all alternatives, modifications, and equivalents included within the spirit and scope of the invention. Moreover, any combination of the above described elements in all possible variations thereof is encompassed by the invention unless otherwise indicated herein or otherwise clearly contradicted by context.

I claim:

1. A container comprising:
a cover comprising:
a first closure portion, said first closure portion being sealingly engageable with a second closure portion of a base so that when said first closure portion and said second closure portion are engaged with each other, said cover and said base define a substantially sealed storage area;
an engagement portion, said engagement portion being engageable with an engagement portion of a second cover, and;
at least one articulation element on said cover; and
a base comprising:
a bottom;
a peripheral sidewall extending from said bottom;
an open top; and
said second closure portion.

2. The container of claim 1 wherein said at least on articulation element circumscribes said engagement portion of said cover.

3. The container of claim 1 wherein said at least one articulation element of said cover is configured as a “V” shaped groove into said cover and having an opened end at a top surface of said cover and a vertex below a bottom surface of said cover.

4. The container of claim 3 wherein said vertex of said articulation element forms a living hinge.

5. The container of claim 3;
wherein said open end of said articulation element has a neutral dimension when no outside force impinges on said cover;
wherein said open end of said articulation element has a midway dimension when a sustained first force impinges on said cover, said midway dimension being greater than said neutral dimension; and
wherein said open end of said articulation element has a bottom dimension when a sustained second force greater than said first force impinges on said cover, said bottom dimension being greater than said midway dimension

6. The container of claim 1 wherein said cover assumes a neutral position, where no outside force impinges on said cover.

7. The container of claim 1 wherein said cover assumes a midway or a bottom position when a user of said container supplies a downward force on said cover.

8. The container of claim 1 wherein said cover and said base comprise a plastic material selected from the group consisting of polystyrene, crystalline polyethylene terephthalate, amorphous polyethylene terephthalate, high density polyethylene, polyvinyl chloride, polycarbonate, and foamed polypropylene.

9. The container of claim 1 wherein said cover is formed by vacuum thermoforming.

10. A cover for a container comprising:
a first closure portion, said first closure portion being sealingly engageable with a second closure portion of a base so that when said first closure portion and said second closure portion are engaged with each other, said cover and said base defining a substantially sealed storage area;
an engagement portion, said engagement portion being engageable with an engagement portion of a second cover, and;
at least one articulation element on said cover.

11. The cover of claim 10 wherein said at least on articulation element circumscribes said engagement portion of said cover.

12. The cover of claim 10 wherein said at least one articulation element of said cover is configured as a “V” shaped groove into said cover and having an opened end at a top surface of said cover and a vertex below a bottom surface of said cover.

13. The cover of claim 10 wherein said vertex of said articulation element forms a living hinge.

14. The cover of claim 10 wherein said cover and said base comprise thermoformed plastic.

15. A thermoforming mold comprising:
a bottom-forming surface;
at least one mold indent having an open end and projecting into said bottom-forming surface; and
wherein said thermoforming mold is used to form a cover comprising:
a first closure portion, said first closure portion being sealingly engageable with a second closure portion of a base so that when said first closure portion and said second closure portion are engaged with each other, said cover and said base define a substantially sealed storage area;
an engagement portion, said engagement portion being engageable with an engagement portion of a second cover, and;
at least one articulation element on said cover.

16. The thermoforming mold of claim 15 wherein said at least one mold indent defines an open-ended cavity having a rectangular shaped cross section.

17. The thermoforming mold of claim 15 wherein said at least one mold indent circumscribes an engagement portion mold element of said thermoforming mold.

18. The thermoforming mold of claim 15 wherein said at least one mold indent is supplied by a separate controllable vacuum system.

19. The thermoforming mold of claim 15 wherein said separate controllable vacuum system draws heated plastic material overlying said open end of said at least one mold indent into said cavity.
